(19) United States
(12) Patent Application Publication
(10) Pub. No.: US 2025/0353069 A1
(43) Pub. Date: Nov. 20, 2025

(54) METHOD FOR PRODUCING A MOTOR VEHICLE COMPONENT BY HOT CUTTING

(71) Applicant: BENTELER AUTOMOBILTECHNIK GMBH, Paderborn (DE)

(72) Inventors: Christian BUSE, Lichtenau (DE); Guenter FORTMEIER, Delbrueck (DE); Oliver LUETKEMEYER, Paderborn (DE); Feng JIAO, Paderborn (DE)

(21) Appl. No.: 19/210,120

(22) Filed: May 16, 2025

(30) Foreign Application Priority Data
May 17, 2024 (EP) 24176674.0

(51) Int. Cl. B21D 53/88; B21D 28/32

(52) U.S. Cl. CPC B21D 53/88; B21D 28/32

(57) ABSTRACT

A motor vehicle component produced by hot forming and press hardening from a hardenable steel sheet plate, and the motor vehicle component has a reinforcement patch which forms a double layer with the steel sheet plate at least in sections. The motor vehicle component has an opening in the region of the reinforcement patch, such that one opening is formed in the reinforcement patch and one opening in the steel sheet plate, and one of the two openings is larger than the other and that the smaller opening is introduced during or after hot forming.

### RELATED APPLICATIONS

The present application claims priority of European Application Number 24176674.0 filed May 17, 2024, the disclosure of which is hereby incorporated by reference herein in its entirety.

### FIELD

The present disclosure relates to a method for producing the motor vehicle component.

### BACKGROUND

Hot forging and press hardening technology is used in the automotive industry to produce sheet metal components for body construction or other motor vehicle components.

For this purpose, a sheet metal plate made of a hardenable steel alloy is heated to above Ac3 temperature. This is around 900° C. or higher, also referred to as austenitization. In this warm state, the component is easy to form. This is called hot forming.

Once the component has been formed, is the component is press-hardened in the next step. This process is also referred to as quench hardening, and the component is cooled at a cooling rate, which is also referred to as the critical cooling rate, from the temperature above the austenitizing temperature which occurs so rapidly that the previously austenitic structure is transformed into a hardened structure, for example, a martensitic structure. Here, tensile strengths Rm of more than 1000 MPa, more than 1300 MPa and, depending on the steel alloy used, also more than 1500 MPa or more than 1800 MPa are able to be achieved.

Depending on the requirements, to the components are able to be additionally reinforced such that components are high-strength or ultra-high-strength components. For this purpose, component patches or reinforcement patches are applied locally. The component patches themselves are also able to be made of a hardenable steel alloy. However, the component patches are also able to be made of another metallic alloy, for example, a steel alloy. In at least one embodiment of the present disclosure, the actual motor vehicle component, made from the steel sheet plate, is formed together with the reinforcing sheet. The reinforcement patches are able to be coupled to the sheet steel plate, for example by welding or gluing.

Furthermore, motor vehicle components are able to be cut or punched in an interior area, and these are able to, for example, be openings for passing through cables, connecting other components or other assembly openings or installation openings for additional components.

Furthermore, during hot cutting, a sheet steel plate is cut or punched in the warm state, i.e., at austenitizing temperature, or in a residually warm state, i.e., in a state before complete hardening. Therefore, the hot cutting process takes place before, during or after hot forming, but before press hardening.

From DE 10 2011 105 514 A1, motor vehicle components are known which are all pre-punched.

From DE 10 2011 120 670 A1 an opening is cut out of a sheet metal component using a laser beam.

### SUMMARY

The object of the present disclosure demonstrates hot-cutting a reinforced component precisely and cost-effectively.

The aforementioned object is achieved according to the present disclosure.

The motor vehicle component is manufactured by hot forming and press hardening from a hardenable steel sheet. The motor vehicle component has a reinforcement patch which forms a double layer with the steel sheet plate, at least in sections. In at least one embodiment of the present disclosure, body components are able to be manufactured as motor vehicle components, for example, motor vehicle pillars, such as an A-pillar, B-pillar or C-pillar. However, other motor vehicle components are also able to fall under the aspect of the present disclosure or be manufactured using the method according to the present disclosure.

First, the steel sheet plate is provided with the reinforcement patch. These are linked together. The coupling is able to be done, for example, by gluing or welding. The steel sheet plate is heated to above austenitizing temperature with the reinforcement patch and then hot-formed and press-hardened. In at least one embodiment of the present disclosure, the sheet steel plate is made of a hardenable steel alloy. The patch or the plate of the patch is also made of a hardenable steel alloy. However, the plate of the patch is able to be made of a non-hardenable steel alloy, and the patch plate is also able to be made of a hardenable steel alloy and the actual steel sheet plate of the motor vehicle component is made of a non-hardenable steel alloy.

In order to enable trimming or punching in an interior area to be carried out in the warm state, the following solution has been developed. The motor vehicle component has an opening in the area of the reinforcement patch. The opening itself passes through the motor vehicle component, thus completely penetrating the area of the sheet steel plate and the area of the reinforcement patch in cross-section. The opening thus completely penetrates the wall thickness or is completely cut out of the wall thickness. Thus, an opening in the area of the sheet steel plate and an opening in the reinforcement patch are able to be seen. Both openings are aligned with each other. In at least one embodiment of the present disclosure, one of the two openings, i.e., either the opening in the sheet steel plate or the opening in the reinforcement patch, is larger than the second opening. According to the present disclosure, the larger opening, also referred to as the pre-hole, has already been introduced into a respective component beforehand, i.e., into the steel sheet plate or into the reinforcement patch in the cold and relatively soft initial state of the steel material.

The second opening, i.e., the opening with the smaller geometric dimension, is then created according to the present disclosure using the hot cutting process. The cutting temperature is able to be between 500° C. and 800° C. or at most between 600° C. and 730° C. A cutting temperature that is too high leads to an unclean cutting edge and, as a result, to increased burr formation. However, due to the double layer, i.e., the adjacent contact of the steel sheet plate and the reinforcement patch, the temperature in this area is higher and lasts longer due to the greater heat capacity of the double layer.

In at least one embodiment of the present disclosure, however, at least the perforation is introduced at a martensite steel temperature of greater than 450° C. of the respective steel alloy.

In at least one embodiment of the present disclosure, the openings are round in cross-section. According to the present disclosure, the cutting is carried out as punching in the interior. However, a different cross-sectional geometry of the opening would also be possible. Therefore, the opening is able to be circular, but also polygonal or oval.

Furthermore, in at least one embodiment of the present disclosure, the smaller opening is at least 5% smaller than the larger opening, which is advantageous. In at least one embodiment of the present disclosure, the smaller opening is 6% to 20% smaller than the larger opening. However, the smaller opening should not be more than 50% smaller than the larger opening.

By adhering to the aforementioned parameters, an almost burr-free edge trim in the opening created by hot cutting is able to be achieved. However, the burr has a length of less than 0.3 mm, or less than 0.2 mm.

A burr may also be formed from the hole with a smaller diameter, which then protrudes into the larger hole. In at least one embodiment of the present disclosure, the burr should then be as flush as possible on the opposite side of the larger hole. Thus, the burr protrudes beyond the plate with the smaller hole, but does not protrude outwards beyond the plate with the larger hole. This creates an additional form fit. In this case, the burr is also able to be called a pull-through.

In at least one embodiment of the present disclosure, a smooth cut portion of greater than 30%, greater than 40%, or approximately 50% in the area of the wall of the opening, is able to be achieved.

In at least one embodiment of the present disclosure, the smaller opening has a collar which projects at least partially into the larger opening. The collar is able to be produced either directly during piercing or punching, whereby the collar is formed before the press hardening is completed, and holes are also able to be first and then pull the collar.

In at least one embodiment of the present disclosure, a self-piercing connecting element is directly inserted into the smaller opening, which closes the smaller opening. This is able to be a punching nut. Furthermore, the self-piercing connecting element, for example, the punching nut, is able to protrude at least partially into the larger opening.

The motor vehicle component is manufactured using a method according to the present disclosure, which has the following features:
Providing a hardenable steel sheet plate and a reinforcement patch and making a larger opening in one of the two parts,
Coupling the two parts in such a way that the steel plate and the reinforcement patch form a double layer,
Heating a sheet steel plate to above Ac3 temperature,
Hot cutting of a smaller opening, wherein a cutting tool cuts through the larger opening,
Hot forming, wherein the cutting operation is carried out during or after hot forming,
Press hardening of the formed motor vehicle component.

First, the individual parts are provided. This is, on the one hand, a steel sheet plate made of a hardenable steel alloy and a reinforcement patch. These two are coupled together, which is produced by welding. The steel sheet with reinforcement patch is then heated to above Ac3 temperature.

One of the two parts is already provided with an opening, which is the larger opening. The then heated pre-material, i.e., the steel sheet plate with the reinforcement patch, is placed in a hot forming tool. In at least one embodiment of the present disclosure, a hot forming tool is combined with a cutting tool or punching tool. In at least one embodiment of the present disclosure, the cutting process is able to be carried out during or after hot forming. This is carried out at a temperature of 500° C. to 800° C. The heated steel sheet cools down due to the initial tool contact with the hot forming tool. In at least one embodiment of the present disclosure, however, the cutting process is carried out before the actual press hardening, i.e., liquid or water cooling of the hot forming tool, takes place. This ensures that an optimal cutting temperature of between 550° C. and 800° C. is maintained. Subsequently, the press hardening process is carried out and the thus hardened component is removed with a tensile strength of Rm above 1000 MPa, above 1300 MPa, and above 1500 MPa. The openings produced within the component thus have a high degree of precision, with the hole or cutting tool experiencing only minimal wear due to the hot cutting process.

### BRIEF DESCRIPTION OF THE DRAWINGS

Further advantages, features, and properties of the present disclosure are the subject matter of the following specification. Embodiment variants are shown in the schematic figures. These simplify the understanding of the present disclosure. In the figures:

FIG. 1A and FIG. 1B the use of a reinforcing component according to the present disclosure of a motor vehicle component,

FIG. 2A to FIG. 2E a first embodiment of the present disclosure with a pre-hole in the steel sheet plate, forming into a motor vehicle part and punching the reinforcement patch,

FIG. 3A to FIG. 3E a second embodiment of the present disclosure with pre-punching of the reinforcement patch and punching of the formed steel sheet plate,

FIG. 4A to FIG. 4E a third embodiment of the present disclosure,

FIG. 5A to FIG. 5E a further embodiment of the present disclosure with insertion of a punch nut.

### DETAILED DESCRIPTION

In the figures, the same reference numerals are used for same or similar components, although a repeated description is omitted for reasons of simplicity. The embodiments described above and below are able to be combined with each other as desired within the scope of the present disclosure without departing from the scope.

In at least one embodiment of the present disclosure, a steel alloy is selected for the steel sheet plate as an alternative or in addition for the reinforcement patch, which is described, for example, as steel A, B, C or D in the table described below. The other of the two plates are then able to be made of the same steel, but also of one of the non-hardenable steels E or F. The alloying elements are given in wt. %, the remainder being iron and impurities due to melting;

| | C | | Si | | Mn | | P | S | Al | | B | | Cr |
|---|---|---|---|---|---|---|---|---|---|---|---|---|---|
| | min | max | min | max | min | max | max | max | min | max | min | max | min |
| Stahl A | 0.19 | 0.25 | 0.1 | 0.4 | 1.1 | 1.4 | 0.02 | 0.005 | 0 | 0.06 | 0.004 | 0.1 | |
| Stahl B | 0.2 | 0.23 | 0.2 | 0.3 | 1.1 | 1.4 | 0.02 | 0.005 | 0 | 0.06 | 0.004 | 0.1 | 0.1 |
| Stahl C | 0.31 | 0.37 | 0.1 | 0.6 | 1 | 1.5 | 0.025 | 0.02 | | 0.1 | 0.001 | 0.004 | 0.08 |
| Stahl D | 0.33 | 0.35 | 0.15 | 0.35 | 1 | 1.5 | 0.025 | 0.015 | 0.01 | 0.08 | 0.001 | 0.004 | 0.08 |
| Stahl E | 0.06 | 0.13 | | 0.7 | | 1.9 | 0.05 | 0.05 | | 0.1 | | 0.003 | |
| Stahl F | 0.07 | 0.11 | 0.02 | 0.6 | 1.2 | 1.6 | 0.03 | 0.01 | 0.01 | 0.07 | 0.0007 | 0.002 | |

| | | Cu | N | Nb | | Ni | | Ti | | V | Mo |
|---|---|---|---|---|---|---|---|---|---|---|---|
| | max | max | max | min | max | min | max | min | max | max | max |
| Stahl A | 0.3 | 0.1 | | | 0.05-Ti | 0.02 | 0.1 | 0.01 | 0.1 | | 0.35 |
| Stahl B | 0.3 | 0.1 | 0.01 | | 0.05-Ti | 0.02 | 0.1 | 0.02 | 0.05 | 0.01 | 0.35 |
| Stahl C | 0.35 | 0.2 | 0.2 | | 0.1 | | 0.2 | 0.002 | 0.05 | | 0.35 |
| Stahl D | 0.5-Mo | 0.2 | 0.2 | 0.01 | 0.06 | | 0.2 | 0.005 | 0.015 | 0.01 | 0.5-Cr |
| Stahl E | 0.15 | 0.2 | 0.2 | | 0.1 | | | | 1.2 | 0.1 | 0.1 |
| Stahl F | 0.15 | 0.2 | 0.2 | 0.04 | 0.1 | | | 0.03 | 0.2 | 0.1 | 0.1 |

For all steels, a metallic pre-coating to protect against corrosion and scaling before hot forming is able to be provided, for example, an AlSi alloy or a Zn alloy or a multi-layer combination thereof.

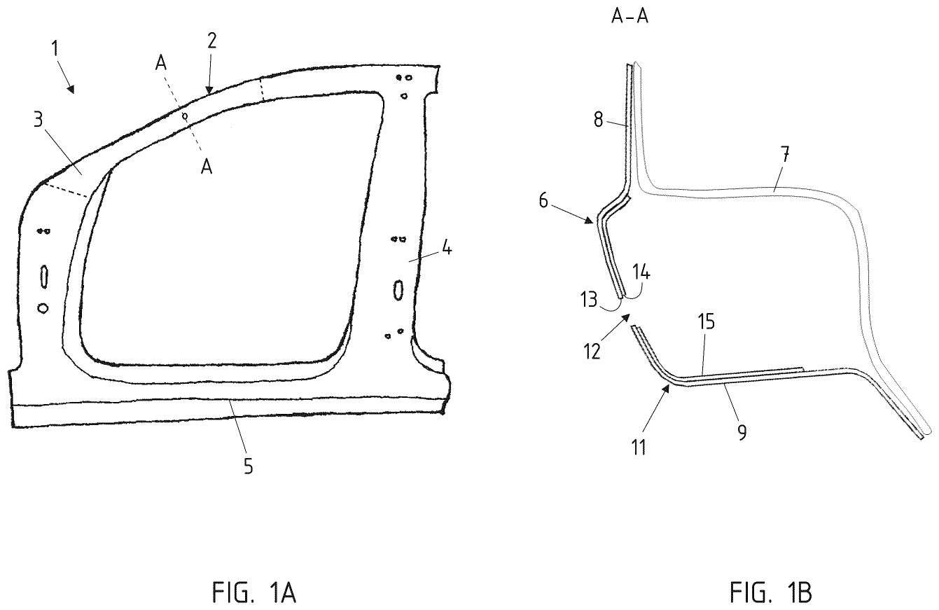

FIG. 1A and FIG. 1B show the use of a reinforcing component according to the present disclosure of a motor vehicle component 1, here in the form of a door ring 2 or a combined A and B pillar 2, 3 with sill 5. The door ring 2 is also able to be called a door ring.

FIG. 1B shows a cross-sectional view along section line A-A, and the area of the A-pillar 2 is formed in cross-section as a closed hollow profile by two adjacent hat-shaped or C-shaped profiles. An inner shell 6 is designed as the motor vehicle component 1 according to the present disclosure and is coupled to an outer shell 7 via a flange 8. The inner shell 6 is formed from an unformed steel sheet plate 9 and additionally has a reinforcement patch 10, so that a double layer 11 is formed in this area. Overall, an opening 12 is thus formed which passes through the double layer 11. For this purpose, a smaller opening 13 and a relatively larger opening 14 are formed.

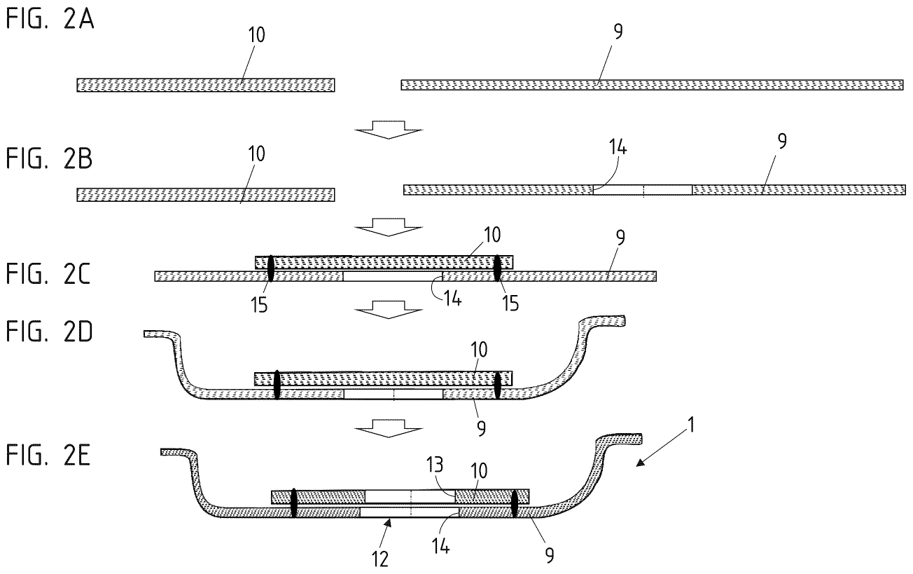

The manufacturing process according to the present disclosure is then further described in FIG. 2A to FIG. 2E. First, a steel sheet plate 9 is provided and an opening 12 is made in the steel sheet plate 9. This may, for example, involve pre-drilling in the sheet steel plate 9. In this case, the larger opening 14 is introduced. For example, the larger opening can be a circular cutout, which then has a corresponding diameter. A reinforcement patch 10 is then placed on according to FIG. 2A to FIG. 2E and coupled to the steel sheet plate 9, for example, via spot welds 15. According to FIG. 2D, a hot forming process then takes place in such a way that a shaping process takes place. For simplification purposes, the area of the opening 12 is shown straight in the forming process. However, the area of the opening 12 is also able to be formed three-dimensionally, for example, in a deep drawing process or other forming process. Likewise, the reinforcement patch 10 and the steel sheet plate 9 lie almost gap-free against each other, which is shown here with a minimal visible gap for simplification reasons. Then, after hot forming, a smaller opening 13 is made in the reinforcement patch 10. Using a hole punch (not shown in detail), this is done either through the larger opening 14, thus, onto the image plane from bottom to top. Alternatively, the hole punch 15 is also able to be brought to the reinforcement patch 10 from behind and guided from top to bottom with respect to the image plane, so that the punch cutout falls out through the larger opening 14. Subsequently, a press hardening process takes place and the component is thus hot-formed and press-hardened and has a high tensile strength Rm.

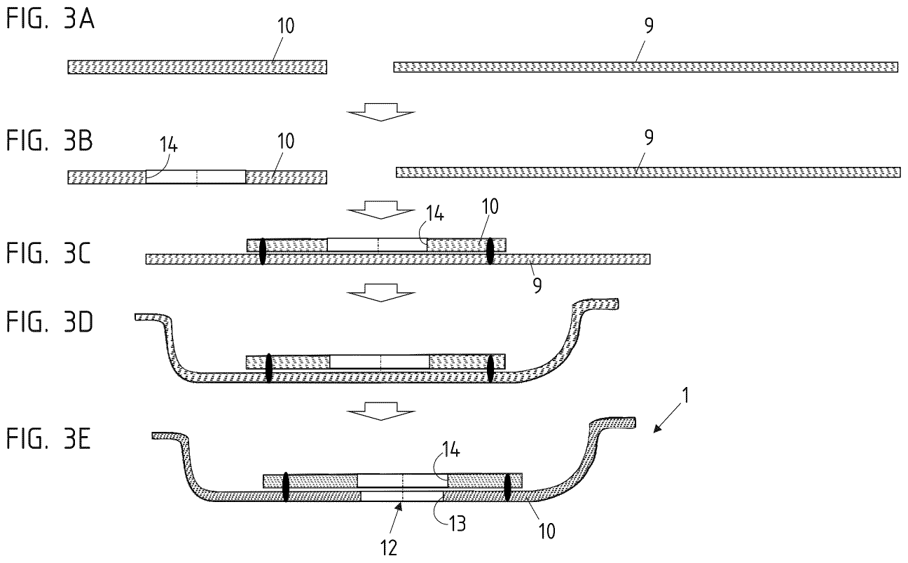

FIG. 3A to FIG. 3E show an analogous process. However, the pre-punching is not carried out on the steel sheet plate 9, but on the reinforcement patch 10. The larger opening 14 is thus located in the reinforcement patch 9. The smaller opening 13 is thus produced in the formed steel sheet plate 9 during or after the hot forming process according to FIG. 3E.

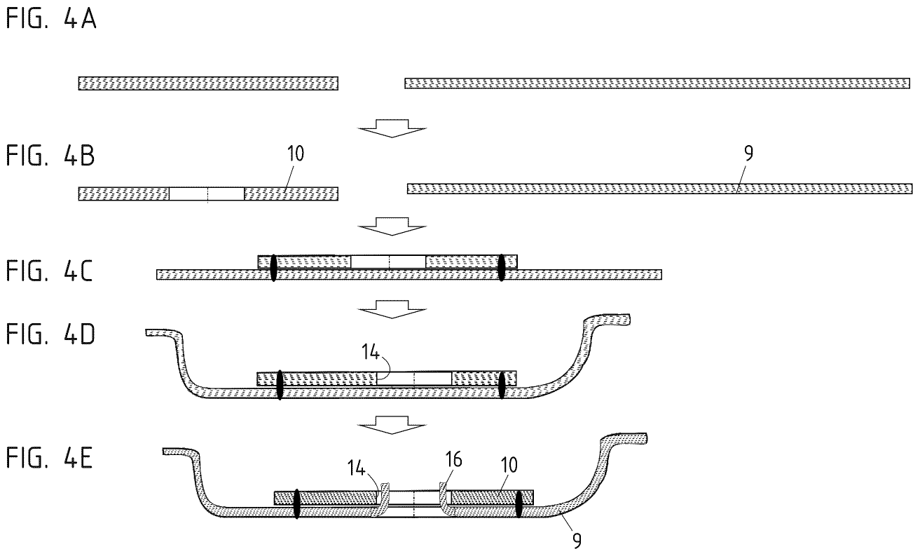

FIG. 4A to FIG. 4E also show an analogous process. The reinforcement patch 10 is also pre-punched. In contrast to FIG. 2A to FIG. 2E and FIG. 3A to FIG. 3E, however, a complete smaller opening 13 is not produced, but the smaller opening 13 is guided through the larger opening 14 according to the principle of pulling a collar. Thus, the bond between reinforcement patch 10 and formed steel sheet plate 9 is further strengthened. Simplified assembly is also able to be carried out here, for example, a thread is able to be screwed into the collar 16 or cables are able to be pulled through.

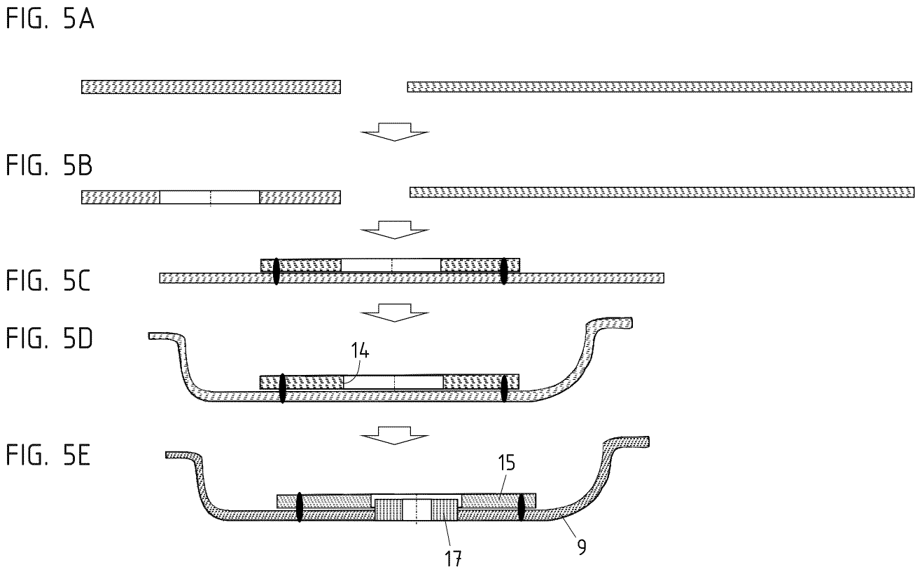

FIG. 5A to FIG. 5E show an analogous process to FIG. 4A to FIG. 4E with the difference that no collar 16 is pulled through here. A stamped component, here in the form of a piercing nut 17, is inserted into the hot-formed steel sheet plate 9. The piercing nut 17 is able to be fixed by a positive connection of the punching process. However, a welding process is also able to take place.

The embodiments according to FIG. 4A to FIG. 4E and FIG. 5A to FIG. 5E are also be modified with regard to the position of the larger pilot hole in the reinforcement plate, so that the larger pilot hole is formed in the sheet steel plate as in FIG. 2A to FIG. 2E.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-10. (canceled)

11. A method of making a motor vehicle component, the method comprising:
forming a first opening in one of a hardenable steel sheet plate and a reinforcement patch;
coupling the steel sheet plate and the reinforcement patch so the steel sheet plate and the reinforcement patch form a double layer;
heating the steel sheet plate and the reinforcement patch to above Ac3 temperature;
hot forming the steel sheet plate and the reinforcement patch into the motor vehicle component;
hot cutting of a second opening smaller than the first opening by a cutting tool which cuts through the first opening, wherein the hot cutting is performed during or after the hot forming; and
press hardening of the motor vehicle component.

12. The method according to claim 11, wherein the hot cutting is performed at a temperature between 500° C. and 800° C.

13. The method according to claim 11, wherein the first opening and the second opening are round in cross section.

14. The method according to claim 11, wherein the first opening is made in the steel sheet plate and the second opening is made in the reinforcement patch.

15. The method according to claim 11, wherein the second opening is at least 5% smaller than the first opening.

16. The method according to claim 11, wherein a hole edge of the second opening has a burr after the press hardening, and a length of the burr is less than 0.3 mm.

17. The method according to claim 11, wherein a wall of the second opening has a smooth cut proportion greater than 25%.

18. The method according to claim 11, wherein the second opening has a collar which projects at least partially into the first opening.

19. The method according to claim 11, wherein the second opening is at least partially closed by a self-piercing connecting element.

20. The method according to claim 19, wherein the self-piercing connecting element projects at least partially into the first opening.

21. The method according to claim 11, wherein the hot cutting is performed at a temperature between 600° C. and 730° C.

22. The method according to claim 11, wherein the first opening is made in the reinforcement patch and the second opening is made in the steel sheet plate.

23. The method according to claim 11, wherein the second opening is 6% to 20% smaller than the first opening.

24. The method according to claim 11, wherein a hole edge of the second opening has a burr after the press hardening, and a length of the burr is less than 0.2 mm.

25. The method according to claim 11, wherein a wall of the second opening has a smooth cut proportion greater than 40%.

26. The method according to claim 11, wherein the second opening is pierced and partially closed by a punching nut.
